(19) United States
(12) Patent Application Publication
(10) Pub. No.: US 2024/0346396 A1
(43) Pub. Date: Oct. 17, 2024

(54) SYSTEMS AND METHODS FOR A LEARNING AND DEVELOPMENT OPERATIONS MANAGEMENT PLATFORM

(71) Applicant: Cognota, Inc., Toronto (CA)

(72) Inventors: Ryan Austin, Toronto (CA); Matthew Ryan Ball, Windsor (CA); Jason Primeau, Meaford (CA); Darren Card, North Vancouver (CA); Yun Du, Markham (CA); Pratik Bidkar, Georgetown (CA); Erick Alejandro Montanez Soda, Merida (MX); Alejandro Ariztegui Abimerhi, Merida (MX); Shruti Bhagwat, Pickering (CA)

(21) Appl. No.: 18/534,599

(22) Filed: Dec. 9, 2023

Related U.S. Application Data
(60) Provisional application No. 63/386,796, filed on Dec. 9, 2022.

(51) Int. Cl. G06Q 10/0631; G06Q 10/10

(52) U.S. Cl. CPC G06Q 10/0631; G06Q 10/103

(57) ABSTRACT

The present invention comprises learning and development content and programs operations management systems and methods. The present systems offers a comprehensive data and requests management system to optimize the handling of learning requests across single or multiple decentralized learning and development teams or groups, integrate and improve the planning, management and assessment of learning and development projects, and synergistically improve and integrate the creation, implementation, practice, and refinement of content design and content design processes of learning and development team professionals and users.

### FIELD OF THE INVENTION

The present disclosure relates to the field of learning and development content and workflow management systems.

The present invention relates to software and learning operations systems, which involves training workflows and instruction design and planning for learning and development teams used to combine, manage, and improve training requests, project planning, and content design processes; and instruction design and planning for learning and development teams to use to combine, manage, and improve training requests, project planning, and content design processes, and other related matters.

### BACKGROUND OF THE INVENTION

Business enterprises seeking to further enhance the knowledge base and promote uniformity of the skills and knowledge base of their workforce are becoming increasingly invested in learning and knowledge development systems to implement an efficient and effective training program for their professionals and skilled workforce. Using cutting-edge software and hardware technology, such systems can be readily implemented locally and globally and updated instantaneously along with concomitant instantaneous updates on the progress of the learning process for individual and group participants.

Learning and Development (“L&D”) is a specialized job function within corporations that focuses on maintaining and improving the skills of personnel to further the objectives of the organization as well as to satisfy business performance, regulatory and compliance, or other learning requirements as prioritized by an organization. Examples of L&D programs could include asbestos awareness training, diversity/sensitivity training, management training, and so on. L&D teams are often decentralized within an organization, posing operational challenges to reducing the duplication of work between teams, challenges to the efficient capacity planning of L&D resources, and challenges to providing management level views of L&D key performance indicators (KPIs), budgets, ROI, and other relevant metrics such as the impact of L&D performance relating to business operations. Training program requests are made to the L&D teams by various business units who are stakeholders in the target outcomes of the program, and who may not be coordinating with one another, potentially duplicating work for the L&D operation as a whole and resulting in suboptimal outcomes.

Furthermore, training projects managed by the L&D team are subject to budgetary and resource constraints, both with scheduling and/or capacity challenges, and predefined phases of completion accompanied by project milestones that tend to be specific to the L&D domain. As such, it is of tremendous benefit to have new, innovative approaches that address these challenges that L&D teams (and the businesses and organizations that they are an important contributing component of) presently face and will encounter to a more heightened degree in the future.

### SUMMARY OF THE INVENTION

Notably, the corporate training market space as a whole is anticipated to face tremendous growth in the years ahead. The present inventive entity is uniquely positioned in the market to offer a single application for the entire learning operations management lifecycle and to integrate seamlessly with downstream learning solutions. The present disclosure offers and provides an effective and efficient system that prioritizes and optimizes synergy between different hardware components and functional modules within the system. The present disclosure also offers methods of enhancing and maximizing the success of the learning and development system for participants. The present inventive vision is uniquely ambitious, as the present disclosure is the first effort to offer a comprehensive solution to the market, that is, from requests for training to business impact and operational excellence. The present invention helps Learning and Development teams improve cycle times, reduce process costs, and enable more efficient delivery of effective learning solutions via ongoing access to data-driven insights.

The present invention also reflects and capitalizes upon the market's increased demand to show impact on learning investments, the increasing need for more corporate training and upskilling of the professional labor force across the enterprise, the need to avoid the costs of ineffective training programs, the desire to avoid low rates of employee engagement, and the shift to new works environments and paradigms (e.g., remote or virtual environments).

The present invention provides novel systems and methods for learning operations management, including systems to manage user and intake form records, track the state of ongoing projects, define milestones, provide notifications to user computers, and generate reports that provide a holistic view of the decentralized activity of disparate user groups across an organization.

One innovative aspect of the system and methods is the specific differentiation of user roles into three types. The user management system is a system consisting of a user database that stores user records; a user manager that, according to a customizable configuration, assigns user records to one of three roles, consisting of an L&D user role, a business user role, and an external user role; and an interface to create, modify and delete user records stored in the database as well as the records that assign a user to one of the three roles. Due to this and other enhancements, the present invention presents an opportunity to establish an innovative and industry-leading community to promote and propagate learning and development operations management thought leadership and to express and enhance the value of learning and development professional efforts across a broad array of enterprises, industries, and geographic regions across the globe.

Indeed, the primary revolutionary aspect to contemporary industry practices of the present invention is the implementation of a single platform approach versus the aggregation (in the prior art) of disparate tools to manage learning operations. The present invention is set to deliver value in any given stage or phase of the learning and development operations lifecycle, and the present invention affords the opportunity to connect this unified approach across stages to optimize enterprise workflows and promote customer value.

The present invention is designed for individual personas. That is, the present invention is a learning and development platform system of capabilities and experiences so that each individual user (persona) experiences unique value tailored to their specific needs. Yet the present invention is also geared toward a role in corporate learning and development with a parallel focus on learning in cross-functional teams, e.g., sales enablement. The present invention enhances and furthers the goal with which all enterprise team members involved in the learning and development process use a single application whereby they are uniform with the rest of their team, even among decentralized, widely distributed teams. The present invention is also geared to the promotion and development of such efforts outside of enterprise learning and development teams to deliver innovative value to a wide array of consumer, business, and organization personas and stakeholders.

### BRIEF DESCRIPTION OF THE DRAWINGS

FIG. 1 schematically illustrates the learning intake system of the present invention.

FIG. 2 presents a diagram of a projects system of the present invention.

FIG. 3 presents a diagram of a learning impact system of the present invention.

FIG. 4 is a diagram of a capacity management system of the present invention.

FIG. 5 is a diagram of a learning strategy system of the present invention.

FIG. 6 is a diagram of a reporting system of the present invention.

FIG. 7 is a flowchart of a method of submitting requests for learning projects via the present invention.

FIG. 8 is a flowchart of a method of updating the state of a project finite state machine via the present invention.

FIG. 9 is a flowchart of a method of improving capacity management via the present invention.

FIG. 10 is an illustration of a user interface of the learning intake system for business users per the present invention.

FIG. 11 is an illustration of a user interface of the learning intake system for learning & development users per the present invention.

FIG. 12 is an illustration of a user interface of the projects system of the present invention.

FIG. 13 is a partial schematic of a data structure for the learning intake, projects, and capacity management systems of the present invention.

### DETAILED DESCRIPTION OF THE INVENTION

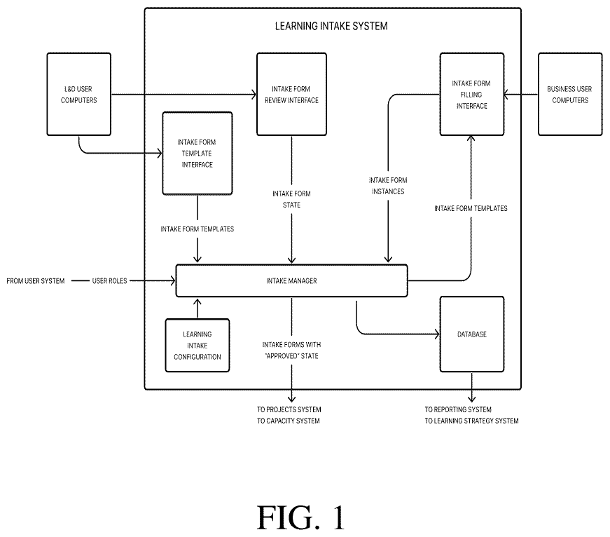

As depicted in FIG. 1, a core aspect and a preferred embodiment of the present invention comprises a learning intake system, which includes: an intake manager; an intake form template interface; an intake form filling interface; a database to store records of intake form templates; a database to store records of instances of intake forms; an intake form review interface; and a database to store records of the state of instances of intake forms according to a customizable configuration that specifies allowable states. The state records stored in the database thereby facilitate the tracking of the intake request throughout the learning operations lifecycle. The database storing intake form templates, the database storing instances of intake forms, and the database storing the state of instances of intake forms may be different databases, or may comprise a single database using schemata to differentiate the records related to intake form templates from the records related to instances of intake forms and from the records related to the state of the instances of intake forms. The configuration can specify that new instances of intake forms are assigned to a “draft” state, whereas completed instances of intake forms can be assigned to a “draft”, “submitted”, “rejected”, “approved” or “waitlisted” state, or other states specified by the configuration. The learning intake manager is configured to authorize, route, and/or reject API requests received from a user computer over a computer network to the learning intake system depending on user role records stored in the user database of the user manager. Users identified as business users by the user manager are authorized by the intake manager to access the intake form filling interface to read intake form template records from the database, to create blank instances of intake forms, to update instances of intake forms by filling blank fields, and to update the state of an instance of an intake form from “draft” to “submitted”. Users identified as L&D users by the user manager are authorized by the intake manager to access the intake form review interface to read instances of intake forms in the “submitted” state and update the state of the records from “submitted” to “rejected”, “approved”, “waitlisted” or other states specified by the configuration. L&D users are also authorized by the intake manager to access the intake form template interface to create new intake form template records, and modify or delete existing intake form template records, and to specify a prioritization or rank for each record. In a particular preferred embodiment of the present invention, the comprehensive system will comprise a learning objectives module, a learning requests module, a learning investments module, a learning projects module, a learning solutions module, and a learning insights module.

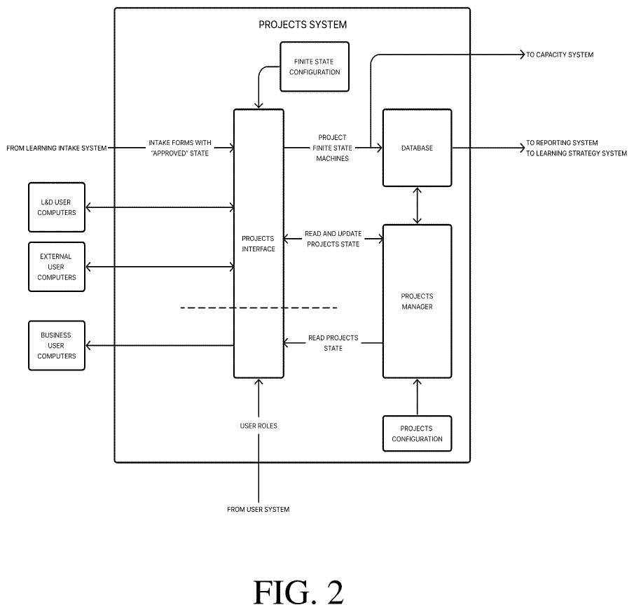

As depicted in FIG. 2, a preferred embodiment of the present invention incorporates a projects system that includes: a projects manager that specifies, creates and instantiates a finite state machine for each project according to the field values of an instance of an intake form in an “approved” state that is associated with the project; a database to store the current state of the finite state machine; a projects interface to view and modify the state of the finite state machine; and a notification manager to notify users of state changes of the finite state machine. The projects manager is configured to authorize, route, and/or reject requests received from a user computer over a computer network to the projects system depending on user role records stored in the user database of the user manager. Users identified as L&D users or as external users by the user manager are authorized by the projects manager to access the projects interface to read and modify the state of the finite state machine of a project, according to a customizable configuration. Through the interface, L&D and external users can also: create and modify records in the projects database related to estimated and actual budget cost of a project; create and modify records in the projects database related to estimate and actual milestones of a project; assign L&D and external users to specific states of the finite state machine of the project, indicating that the L&D or external user in question will perform work on the project associated with the state. Users identified as business users by the user manager are authorized by the projects manager to have access to the projects interface to view the current state of the finite state machine associated with a project, view which L&D or external users are assigned to do work in each state of the finite state machine associated with the project, view records of the estimated or actual budget costs associated with the project, and view records of the estimated or actual milestone of the project.

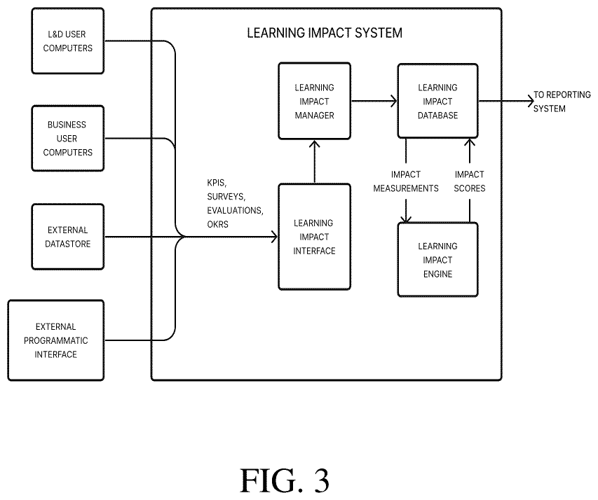

As depicted in FIG. 3 herein, a preferred embodiment of the present invention includes a learning impact system consisting of a learning impact manager, a learning impact interface, a learning impact engine, and a database. The learning impact manager is a component that computes the performance and impact of the learning projects, attributing the delivery of the project to changes in underlying ROI metrics, according to a customizable configuration. The metrics include key performance indicators (KPIs) or other objectives of the learning project as defined in the project request by the L&D user or business user that created the request. Input measurements are fed to the learning impact database via the learning impact interface by sources authorized by the learning impact manager, which could include specific users through a user interface, or from user computers over a computer network through a programmatic interface. The learning impact engine queries learning impact measurements and an impact configuration from the database to compute an impact score, which is an estimate of the fraction of the change in the specified metric that is attributable to the delivery and use of the learning project. Learning impact measurements can include: identities, including anonymized identifiers, of learners who had been enrolled in the work product of a learning project; results of self-assessment surveys taken by the learners that cover their assessment of the value of the learning program, how much they learned, and how it has impacted their behavior; results of management surveys taken by the managers of the learners asking the same questions; performance evaluations of the learners according to subjective and objective criteria; values of departmental and business OKRs of the organization that requested the learning project; and other measurements known to those familiar with the current state of the art to be indicative of learning outcomes.

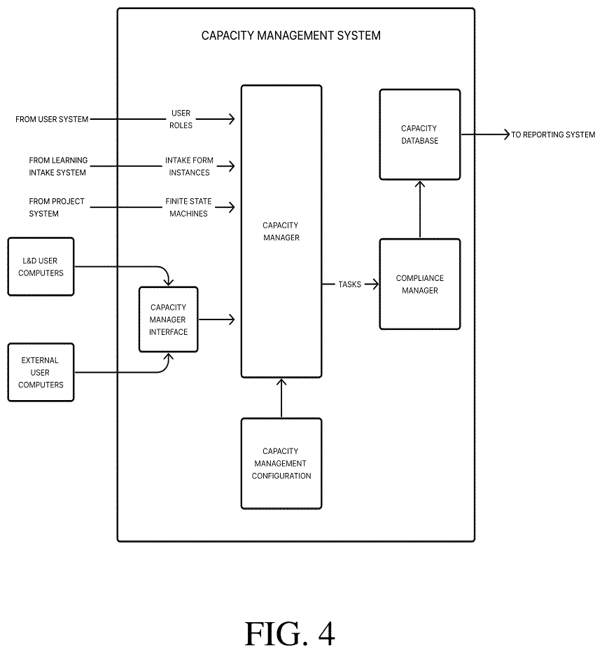

As depicted in FIG. 4, a capacity management system comprises another aspect of a preferred embodiment of the invention, consisting of a capacity manager, capacity interface, and capacity database. The capacity database presents and maintains records and configuration related to capacity of individual L&D and external users, including their work schedule, available hours, scheduled time off, their current allocation of work tasks, and historical statistics of prior tasks completed and estimated vs. actual time spent on such tasks. A task is a unit of work performed by an L&D or external user and is associated with either responding to a learning request or completing a learning project that is derived from a learning request. Task assignments are indexed in the database by reference to such parameters including: the task's corresponding learning request identification or learning project identification; the business team that requested the project; the priority level of the task; the project type; and the user identifications of the L&D and external users who are collaborating on related tasks. The capacity manager calculates expected value of human resources (such as person-hours), and non-human resources required to complete a backlog of tasks through a historical analysis of the actual resources required to complete similar tasks, according to a similarity metric. Factors in estimating task similarity metrics include: project type and description, task type and description, available budget, the users assigned to the tasks, and the attributes of the business team and organization requesting the work. These and other factors are provided as inputs to the capacity manager and combined according to a configuration to estimate required resources to complete the work, and to flag whether adequate capacity exists to fulfill the requirements of the work by the specified deadline. A compliance manager is a component of the capacity system that advises and/or suggests and/or restricts capacity and work allocations to confirm with regulatory requirements of each user based on their jurisdiction, including maximum allowable hours of work per week or per other relevant time period, mandatory holidays, mandatory minimum time-off, and so on.

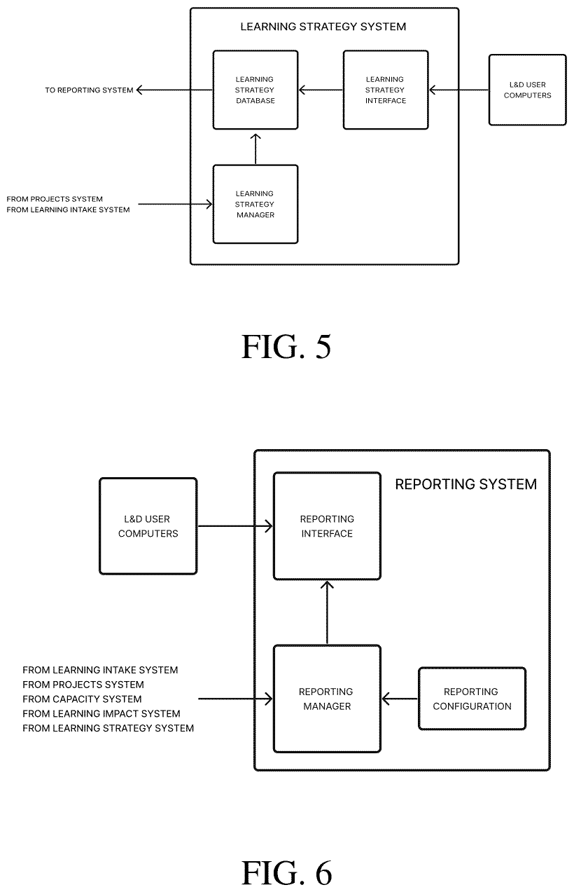

As depicted in FIG. 5, a learning strategy system comprises another aspect of a preferred embodiment of the invention, consisting of a system and method for creating database records of business objectives, and/or records of L&D functional objectives, and associating learning request records and learning project records with the business objective records and the L&D functional objective records. The system includes a learning strategy database that stores the records of business objectives and L&D functional objectives, such as skills gaps in the organization, and the records of association between the objective records and learning request records and learning project records. In a particular preferred embodiment of the invention, the system incorporates an objectives data store, a projects data store, a requests data store, an investments data store, a project solutions data store, and a project insights data store. Also included in a preferred embodiment of the system is a learning strategy interface where users can enter and update business and L&D functional objectives and their associations with learning requests, and/or learning projects, either through a graphical user interface or through a programmatic interface. A learning strategy manager is a component of the system that queries the learning strategy database, the learning request database, and the learning projects database, and displays via the learning strategy interface return-on-investment metrics associated with the completion of learning requests and learning projects that are associated with each business objective record and L&D functional objective record.

As depicted in FIG. 6, a preferred embodiment of the present invention incorporates a system and method for generating and delivering reports that provide a holistic view of the decentralized activity of several disparate L&D teams. The reporting system includes a reporting manager that accesses a configuration in a reporting database, and according to the configuration fetches records from the learning intake database and the projects database. The reporting manager and its configuration provide a method for generating the queries and query parameters that are specific to the type of user requesting reports, by fetching the user type and user record details from the user database. The reporting interface is an interface that facilitates a user requesting reports and provides visual representations of the resulting datasets of records fetched from the learning request database, or the learning project database, or the capacity database, or the learning strategy database, or any combination thereof. As the systems of the invention collocate data records from one or more disparate L&D teams into common databases, the reporting system can efficiently create reports at different scales (individual, team, manager, department, division, corporate, etc.), aggregating and filtering data using one or more common keys.

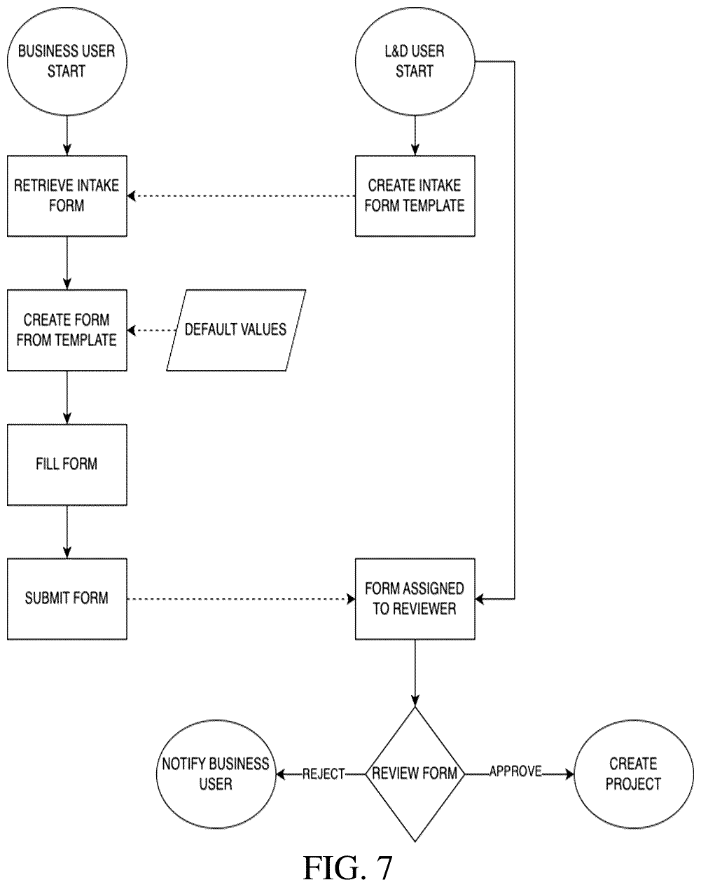

As depicted in a FIG. 7, a preferred embodiment of the present invention comprises an innovative method of submitting requests for learning projects as a component of the L&D operations management system. In such an embodiment, an L&D user may create an L&D intake form template, which may then be retrieved by a business user or, alternatively, the business user may create a form from a form template, including optionally incorporating existing or default values from the associated L&D database. The business user may fill and submit the form, whereupon the form is assigned to an L&D reviewer. The L&D reviewer may approve the form and create a project relevant and responsive to the requests, or the reviewer may reject the form and notify the business user of the rejection.

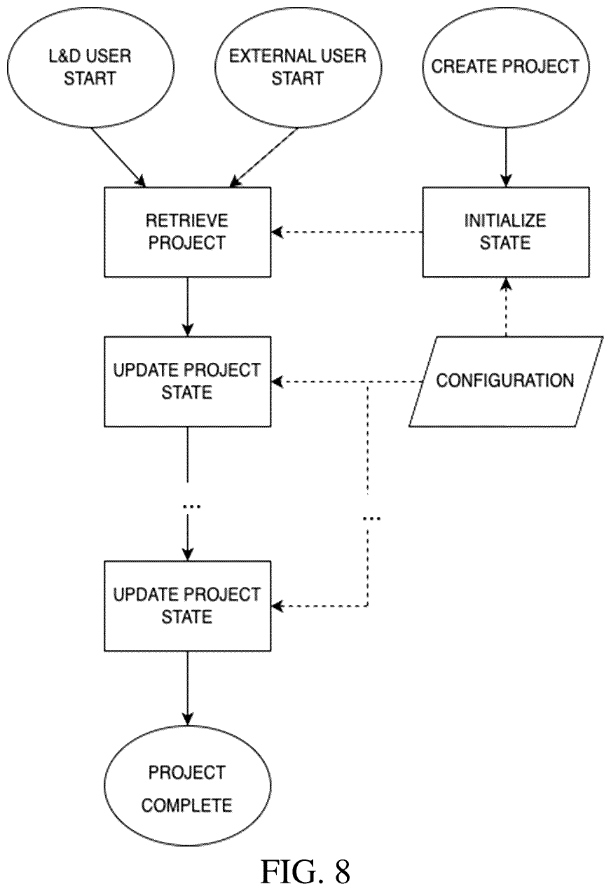

As depicted in FIG. 8, a preferred embodiment of the present invention comprises a novel and innovative method of updating the state of a L&D project finite state machine. Upon creation or initiation of a new L&D project, with the concomitant establishment of an initialized project state, L&D users and/or external users may retrieve the project. Upon assumption and active progress within the project by users, the project configuration and project state is correspondingly efficiently and effectively updated by the system.

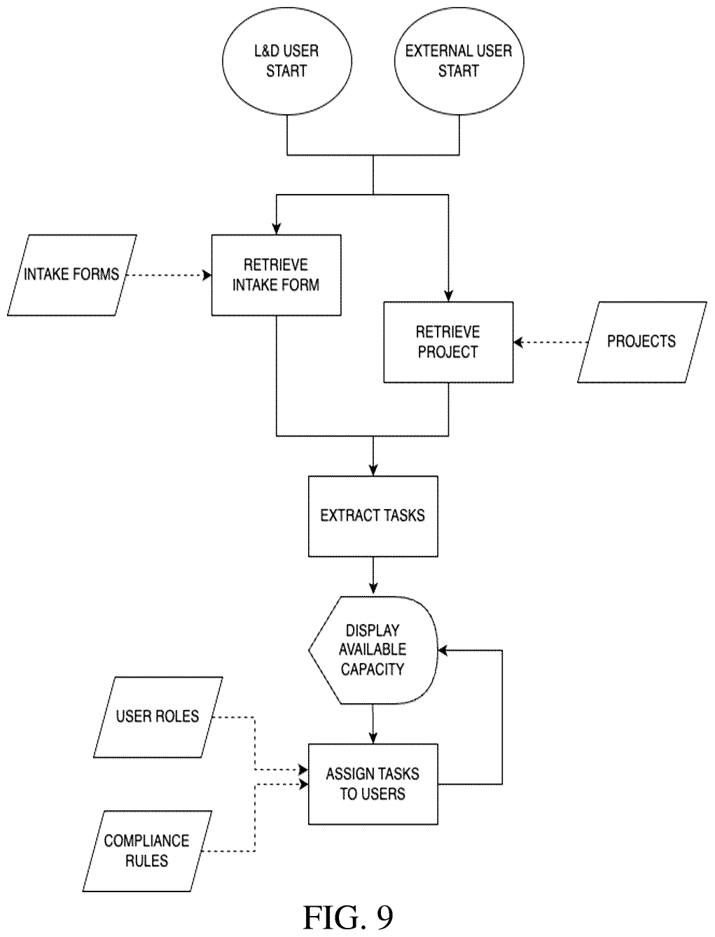

As depicted in FIG. 9, a preferred embodiment of the present invention comprises a novel and innovative method of improving capacity management of an L&D operations management system. At project initiation, L&D users and/or external users may retrieve L&D projects and retrieve relevant intake forms for new projects. The users extract tasks from active projects and the system correspondingly monitors and displays available L&D system capacity, further in conjunction with the assignment of new or further tasks to users in view of corresponding user roles and project and system compliance rules.

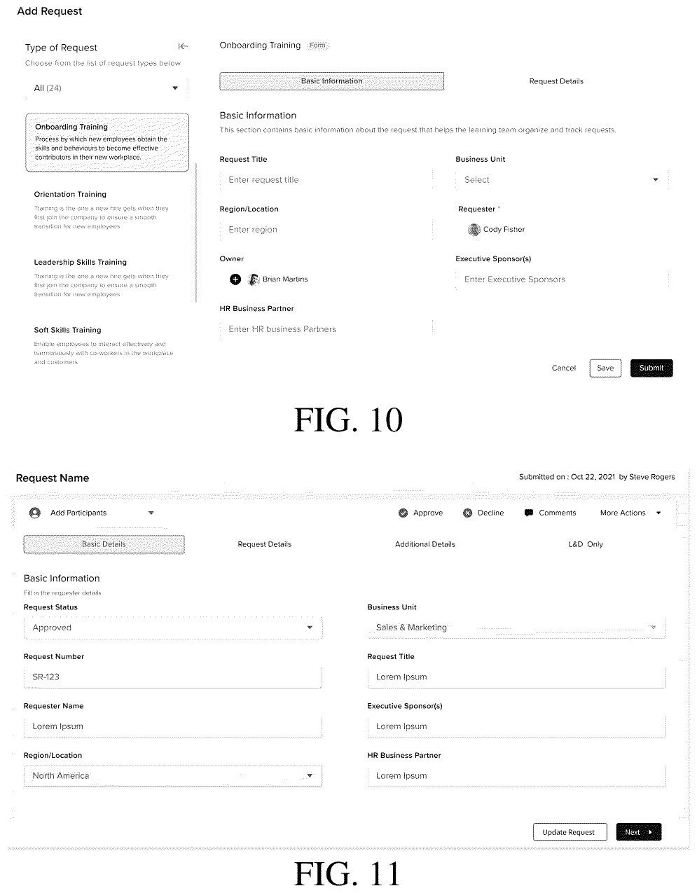

FIG. 10 illustrates an exemplary preferred embodiment of a user interface of the learning intake systems of the present invention for business users. In a most preferred embodiment, a uniformity is maintained across users, even across departments, offices, and disparate nations in the user interface for a unified business organization, and the present invention allows that modifications to the user interface may be readily implemented simultaneously organization-wide where necessary, expedient, or desired.

FIG. 11 illustrates an exemplary preferred embodiment of a user interface of the learning intake systems of the present invention for learning and development users. As per FIG. 10, in a most preferred embodiment, a uniformity is maintained across users, even across departments, offices, and disparate nations in the user interface for a unified business organization, and the present invention allows that modifications to the user interface may be readily implemented and updated simultaneously organization-wide where necessary, expedient, or desired.

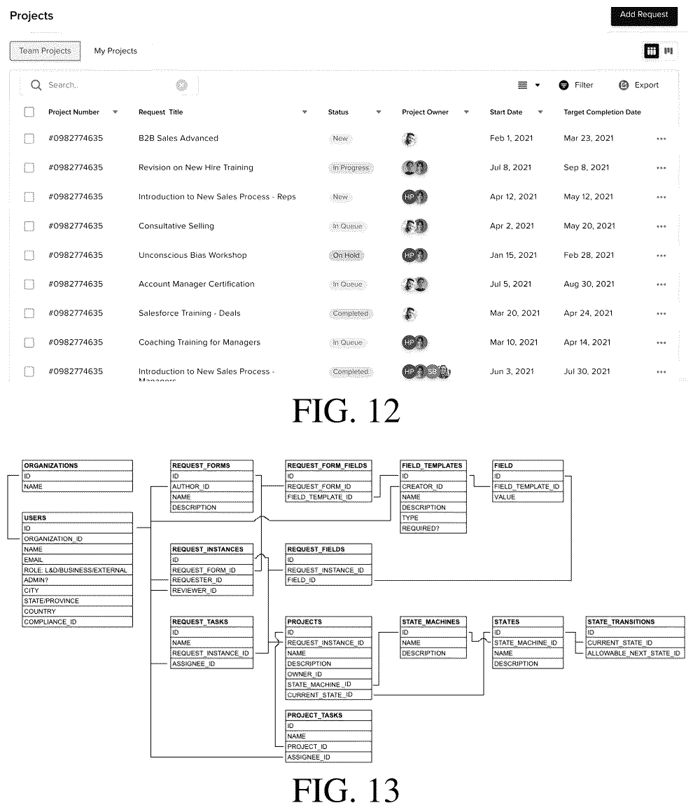

FIG. 12 illustrates an exemplary preferred embodiment of a user interface of the projects systems of the present invention. As per the above, in select preferred embodiments, a uniformity is actively maintained and preserved across users, including across departments, offices, and disparate nations in the user interface for a unified business organization, and the present invention allows that modifications to the user interface may be readily implemented and updated simultaneously organization-wide where necessary, expedient, or desired.

FIG. 13 provides a partial schematic illustration of a preferred embodiment of a data structure for the learning intake, projects, and capacity management systems of the present invention. In a preferred embodiment of the present invention, the data structure is effectively configured to permit for the ready addition or modification of data fields and categories and is configured for the near-instantaneous modification, updating, and securing of data structures and records organization-wide, even across departments, resources, physical offices and physical locations.

In preferred embodiments of the present invention, the learning and development operations management system will comprise: (1) a learning and development program participant, content, and records intake system; (2) a learning and development project management system; (3) a learning and development program project management system; (4) a learning and development programs measurements data, records, and data and records reporting system; (5) a learning and development program impact measurement data, feedback, and evaluative system; (6) a learning and development programs content and resources capacity management system; and (7) a learning and development programs strategy implementation and records system, further such that the systems are temporally and functionally enhanced and interconnected as an integrated learning and development content and practice operations management system. In a particular preferred embodiment, the learning and development operations management interconnected systems are interconnected through at least one shared database. In a preferred embodiment of the present invention, the learning and development operations management system may be seamlessly overlaid over, or readily supplant, prior existing alternate learning and development management systems, tools, and records without material interruption in operations or substantial data loss. In a particular preferred embodiment, the learning and development programs project management system provides substantially real-time translations of learning and development program content, reports, and records to a language selected by the user, supervisor, L&D team member, or systems administrator.

While various embodiments of the invention have been described, it will be apparent to those of ordinary skill in the art that many more embodiments and implementations are possible that are within the scope of the invention. In addition, the various features, elements, and embodiments described herein may be claimed or combined in any combination or arrangement.

What is claimed is:

1. A learning and development operations management system, comprising:
a learning participant, content, and records intake system,
a learning and development project management system,
a learning and development measurements, records, and reporting system,
a learning impact measurement and evaluative system,
a learning and development content and resources capacity management system,
a learning strategy records and implementation system,
wherein the systems are temporally and functionally enhanced and interconnected as an integrated learning and development operations management system.

2. The learning and development operations management system of claim 1, wherein the interconnected systems are further interconnected through at least one shared database.

3. The learning and development operations management system of claim 1, wherein the communications and records of the interconnected systems are secure.

4. The learning and development operations management system of claim 1, wherein the system may be overlaid or supplant prior existing alternate learning and development management systems and records.

5. The learning and development operations management system of claim 1, wherein the system provides real-time translations of contents and records to a language selected by user.
